(19) United States
(12) Patent Application Publication
(10) Pub. No.: US 2025/0216643 A1
(43) Pub. Date: Jul. 3, 2025

(54) LENS MODULE AND DEVICE HAVING THE LENS MODULE

(71) Applicant: TRIPLE WIN TECHNOLOGY(SHENZHEN) CO. LTD., Shenzhen (CN)

(72) Inventor: HUNG-LUNG HO, New Taipei (TW)

(21) Appl. No.: 18/606,137

(22) Filed: Mar. 15, 2024

(30) Foreign Application Priority Data
Dec. 27, 2023 (CN) 202311821201.3

(51) Int. Cl. G02B 7/02

(52) U.S. Cl. CPC G02B 7/021

(57) ABSTRACT

A lens module with stable back focal length and a device having the lens module are provided. The lens module includes a lens assembly, a holder, a circuit board, and a sensor. The coefficient of thermal expansion of the holder is less than or equal to 0.6 (10⁻⁵ cm/cm/° C.), thus, the deformation of the holder can be almost ignored, and the distance between the lens assembly and the sensor (i.e., the back focal length) will remain unchanged, thereby reducing image blurring caused by changes in the back focal length.

### FIELD

The subject matter herein generally relates to optical devices, and more particularly, to a lens module and a device having the lens module.

### BACKGROUND

Nowadays, lens modules are widely used in auxiliary driving of vehicles for reverse image display, vehicle surrounding view display, etc. The vehicle lens module generally includes a lens assembly, a holder, and a sensor.

The holder is usually made of polycarbonate (PC), a combination of polycarbonate and glass fiber (GF), polyamide (PA), liquid crystal polymer (LCP), etc. When the temperature of the vehicle rises due to sunlight exposure or other reasons, the holder made of the above materials is expanded, resulting in a change in the distance between the lens assembly and the sensor (i.e., the back focal length defocus), thus causing image blurring.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a diagrammatic view of an embodiment of a lens module according to the present disclosure.

FIG. 2 is an exploded view of the lens module of FIG. 1.

FIG. 3 is a cross-sectional view along a view line III-III shown in FIG. 1.

FIG. 4 is a diagrammatic view of an embodiment of a device according to the present disclosure.

### DETAILED DESCRIPTION

Unless otherwise defined, all technical and scientific terms used herein have the same meaning as commonly understood by persons skill in the art. The terms used herein are only for the purpose of describing specific embodiments, and not intended to limit the embodiments of the present application.

It should be noted that all directional indications (such as up, down, left, right, front, back, etc.) in the embodiments of the present application are only used to explain the relative positional relationship or movement between various components under a certain posture (as shown in the drawings). If the specific posture changes, the directional indication also changes accordingly.

It should be noted that when a component is referred to as being “fixed on” or “mounted on” another component, it may be directly on the other component or there may also be an intervening component. When a component is considered to be “set on” another component, it may be in direct contact with the other component or there may also be an intervening component.

The embodiments of the present application are described here with reference to sectional views, which are schematic diagrams of idealized embodiments (and intermediate structures) of the present application. Therefore, the difference in the shape of the drawing due to the manufacturing process and/or tolerance is predictable. Accordingly, the embodiments of the present application should not be interpreted as limited to the specific shape of the area illustrated here, but should include, for example, the deviation of the shape due to manufacturing. The areas shown in the drawings are only schematic, and their shape is not used to illustrate the actual shape of the device, and is not used to limit the scope of the present disclosure.

Some embodiments of the present application will be described in detail below with reference to the drawings. The following embodiments and features of the embodiments may be combined with each other in the absence of conflict.

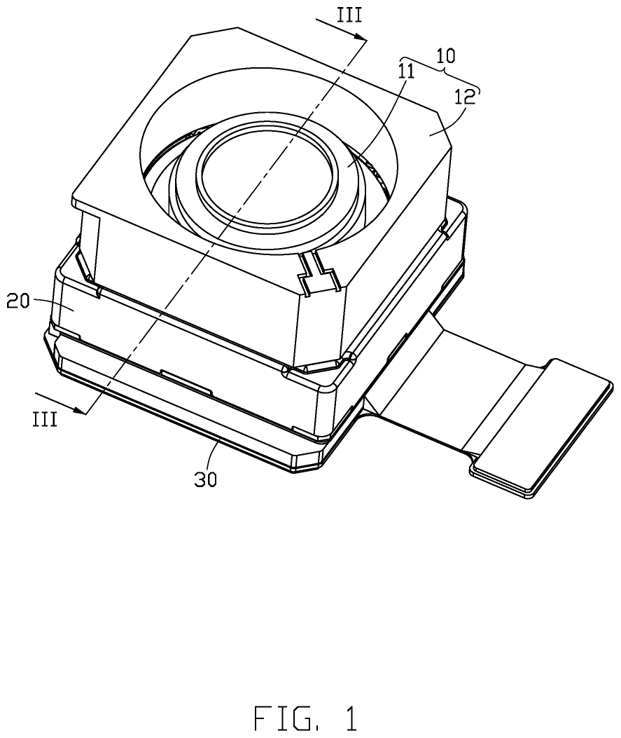

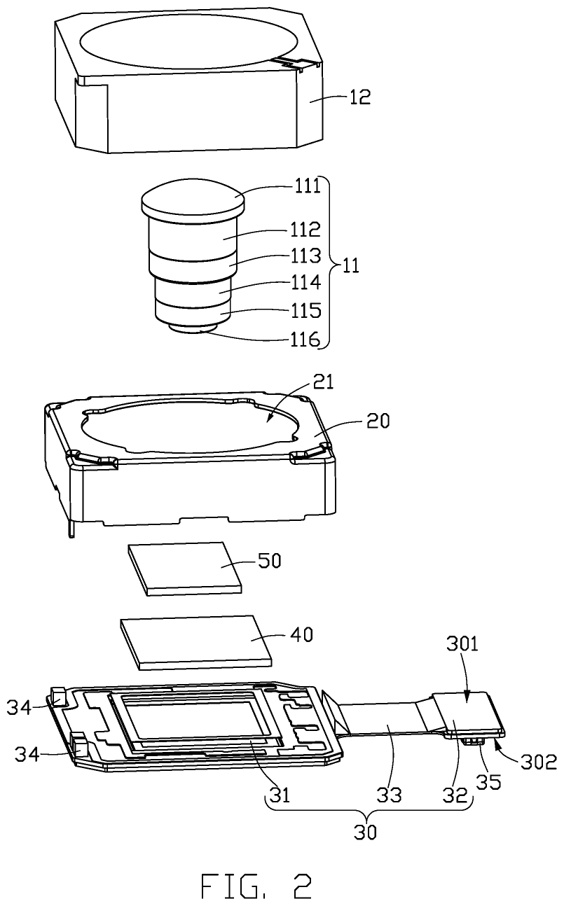

Referring to FIGS. 1 and 2, an embodiment of the present application provides a lens module 100 including a lens assembly 10, a holder 20, a circuit board 30, and a sensor 40. The lens assembly 10 includes a lens 11 and a lens barrel 12 accommodating the lens 11. The holder 20 defines a cavity 21, and a surface of the holder 20 away from the circuit board 30 is partially recessed to form the cavity 21. At least a portion of the lens assembly 10 is accommodated within the cavity 21, and one end of the lens assembly 10 may be outside the cavity 21. The holder 20 is disposed on the circuit board 30.

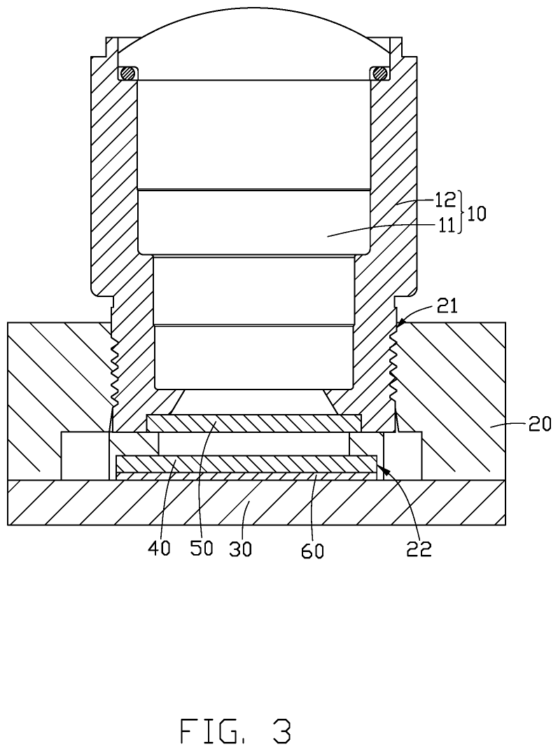

Referring to FIG. 3, a surface of the holder 20 facing the circuit board 30 is partially recessed to form a groove 22. The sensor 40 is disposed within the groove 22 and corresponds to the lens assembly 10. The corresponding relationship of the sensor 40 and the lens assembly 10 refers to that the orthogonal projection of the lens assembly 10 can cover the orthogonal projection of the sensor 40, and the sensor 40 is located on the optical path of the lens assembly 10.

The coefficient of thermal expansion of the holder 20 is less than or equal to 0.6 (10⁻⁵ cm/cm/° C.). The coefficient of thermal expansion refers to the degree of expansion or contraction of a material, specifically indicating the amount of elongation or shrinkage per unit length of the material when the temperature rises by one degree Celsius. In other words, when the temperature rises by 1° C., the elongation per unit length of the holder 20 will be less than or equal to 0.6×10⁻⁵ cm. Thus, even if the temperature rises, the deformation of the holder 20 is small, and the distance between the lens assembly 10 and the sensor 40 (i.e., the back focal length) will almost remain unchanged, thereby reducing image blurring caused by changes in the back focal length.

In some embodiments, the holder 20 is made of titanium alloy, and the coefficient of thermal expansion of titanium alloy is 0.6 (10⁻⁵ cm/cm/° C.). Common holder materials include polycarbonate, a combination of polycarbonate and glass fiber, polyamide and so on. The coefficient of thermal expansion of polycarbonate is 6.5 (10⁻⁵ cm/cm/° C.), the coefficient of thermal expansion of the combination of polycarbonate and glass fiber is 4.0 (10⁻⁵ cm/cm/° C.), and the coefficient of thermal expansion of polyamide is 6.5 (10⁻⁵ cm/cm/° C.). The coefficient of thermal expansion of titanium alloy is much smaller than that of the common holder materials. The titanium alloy can be processed through die casting or machining to achieve the required shape and dimensional accuracy of the holder 20.

Furthermore, the titanium alloy includes titanium (Ti), aluminum (Al), and vanadium (V), with the content of aluminum being 6 wt. % and the content of vanadium being 4 wt. %. That is, the titanium alloy is of grade TC4, with a composition of Ti-6Al-4V, also known as Ti6Al4V or Ti 6-4. The TC4 titanium alloy has good plasticity and is easy to forge, roll, and stamp.

Furthermore, the titanium alloy also includes iron (Fe) and oxygen (O), with the content of iron being less than or equal to 0.25 wt. % and the content of oxygen being less than or equal to 0.2 wt. %. That is, in the Ti-6Al-4V, the maximum content of iron is 0.25 wt. %, and the maximum content of oxygen is 0.2 wt. %.

In some embodiments, an external thread (not shown in the figure) is defined on the outer surface of the lens barrel 12 near the end where the sensor 40 is located, and an internal thread (not shown in the figure) matching the external thread is defined inside the cavity 21 of the holder 20. By engaging the external thread with the internal thread, the lens assembly 10 can be accommodated inside the cavity 21 of the holder 20.

In some embodiments, an adhesive layer 60 is arranged inside the groove 22, and the adhesive layer 60 is configured to fix the sensor 40 inside the groove 22. The adhesive layer 60 may be formed by applying an adhesive inside the groove 22 and solidifying the adhesive at room temperature. The adhesive may be a metal-specific adhesive such as Kingkou K-660 (trade name) for bonding between metal materials, as well as for bonding between metal and plastic, silicone, rubber, wood, sponge, leather, and other materials. The Kingkou K-660 has chemical properties such as room temperature curing, easy operation, high bonding strength, quick positioning, and low whitening.

In some embodiments, as shown in FIG. 2, the lens 11 may include a first lens portion 111, a second lens portion 112, a third lens portion 113, a fourth lens portion 114, a fifth lens portion 115, and a sixth lens portion 116, which are connected in sequence (from the phase side to the object side or from the object side to the phase side) and coaxially arranged. The diameter of the first lens portion 111 may be smaller than the diameter of the second lens portion 112, and the diameters of the second lens portion 112, the third lens portion 113, the fourth lens portion 114, and the fifth lens portion 115 gradually increase in sequence. In some embodiments, along the direction from the first lens portion 111 to the second lens portion 112, the diameter of the second lens portion 112 gradually increases, and the diameter of the third lens portion 113 gradually increases. In other embodiments, the diameters of the second lens portion 112 and the third lens portion 113 may also remain constant. In other embodiments, the number and diameters of the lens portion can also be adjusted according to actual needs.

In some embodiments, the circuit board 30 may be a flexible printed circuit (FPC), a rigid printed circuit board, or a flexible-rigid circuit board. In this embodiment, the circuit board 30 is a flexible-rigid circuit board. As shown in FIG. 2, the circuit board 30 includes a first rigid board portion 31, a second rigid board portion 32, and a flexible board portion 33 between the first rigid board portion 31 and the second rigid board portion 32. The circuit board 30 has a first surface 301 facing the holder 20 and a second surface 302 opposite to first surface 301. Multiple electronic components 34 are mounted on the first surface 301 of the first rigid board portion 31, and the holder 20 may be mounted on the first surface 301 of the first rigid board portion 31 through an adhesive (not shown in the figure). In other words, the holder 20 and the electronic components 34 are located on the same surface of the circuit board 30. The electronic components 34 may be, but not limited to, a resistor, a capacitor, a diode, a transistor, a relay, an electrically erasable programmable read-only memory (EEPROM), and other passive components. The sensor 40 may be disposed opposite to the first surface 301 of the first rigid board portion 31.

Furthermore, as shown in FIG. 2, an electrical connection portion 35 is mounted on the second surface 302 of the second rigid board portion 32. In other words, the electrical connection portion 35 and the electronic components 34 are located on different surfaces of the circuit board 30. The electrical connection portion 35 can be used to achieve signal transmission between the lens module 100 and an external electronic device (not shown in the figure). The electrical connection portion 35 may be, but is not limited to, a connector or gold fingers.

In some embodiments, as shown in FIG. 3, the lens module 100 further includes a filter 50. The filter 50 is disposed inside the cavity 21 and located on the optical path of the lens 11. The filter 50 is located between the lens 11 and the sensor 40. The filter 50 may be set in the cavity 21 of the holder 20 through an adhesive (not shown in the figure), and the filter 50 is opposite to the sensor 40. The filter 50 is used to filter out infrared light to ensure image quality.

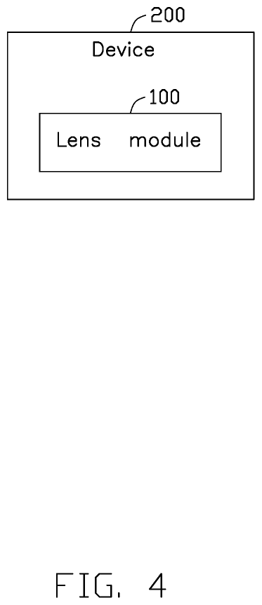

Referring to FIG. 4, the present application also provides a device 200, which includes the lens module 100 described above. The device 200 may be but is not limited to a vehicle, a mobile phone, a wearable device, a monitoring device, etc.

The present application selects a material with a coefficient of thermal expansion less than or equal to 0.6 (10⁻⁵ cm/cm/° C.) as the holder 20, so that when the temperature rises, the deformation amount of the holder 20 may be small, and the distance between the lens assembly 10 and the sensor 40 (i.e., the back focal length) can almost remain unchanged, thereby reducing image blurring caused by changes of the back focal length.

The above descriptions are some specific embodiments of the present application, but the actual application process cannot be limited only to these embodiments. For those of ordinary skill in the art, other modifications and changes made according to the technical concept of the present application should all belong to the protection scope of the present application.

What is claimed is:

1. A lens module comprising:
a lens assembly comprising a lens and a lens barrel for accommodating the lens;
a holder defining a cavity and a groove, wherein at least a portion of the lens assembly is accommodated within the cavity, and a coefficient of thermal expansion of the holder is less than or equal to 0.6 (10⁻⁵ cm/cm/° C.);
a circuit board, where the holder is arranged on the circuit board; and
a sensor, wherein the groove on the holder is partially recesses on a surface of the holder facing the circuit board, and the sensor is arranged in the groove.

2. The lens module of claim 1, wherein the holder is made of titanium alloy.

3. The lens module of claim 2, wherein the titanium alloy comprises titanium, aluminum, and vanadium (V), a content of aluminum in the titanium alloy is 6 wt. %, and a content of vanadium in the titanium alloy is 4 wt. %.

4. The lens module of claim 3, wherein the titanium alloy further comprises iron and oxygen, a content of iron in the titanium alloy is less than or equal to 0.25 wt. %, and a content of oxygen in the titanium alloy is less than or equal to 0.2 wt. %.

5. The lens module of claim 1 further comprising an adhesive layer arranged in the groove, wherein the adhesive layer fixes the sensor in the groove.

6. The lens module of claim 1, wherein the circuit board comprises a first rigid board portion, a second rigid board portion, a flexible board portion arranged between the first rigid board portion and the second rigid board portion, and an electronic component; the circuit board has a first surface facing the holder and a second surface opposite to the first surface, the electronic component is arranged on the first surface of the first rigid board portion, and the holder is arranged on the first surface of the first rigid board portion.

7. The lens module of claim 6, wherein the circuit board further comprises an electrical connection portion arranged on the second surface of the second rigid board portion, and the electrical connection portion comprises a connector or gold fingers.

8. The lens module of claim 1 further comprising a filter arranged in the cavity and located on an optical path of the lens.

9. The lens module of claim 1, wherein the lens comprises a first lens portion, a second lens portion, a third lens portion, a fourth lens portion, a fifth lens portion, and a sixth lens portion, which are connected in sequence and coaxial with each other.

10. The lens module of claim 9, wherein a diameter of the first lens portion is smaller than a diameter of the second lens portion, and diameters of the second lens portion, the third lens portion, the fourth lens portion, and the fifth lens portion gradually increase in sequence.

11. A device comprising:
a lens module comprising:
a lens assembly comprising a lens and a lens barrel for accommodating the lens;
a holder defining a cavity and a groove, wherein at least a portion of the lens assembly is accommodated within the cavity, and a coefficient of thermal expansion of the holder is less than or equal to 0.6 (10⁻⁵ cm/cm/° C.);
a circuit board, where the holder is arranged on the circuit board; and
a sensor, wherein the groove on the holder is partially recesses on a surface of the holder facing the circuit board, and the sensor is arranged in the groove.

12. The device of claim 11, wherein the device comprises a vehicle, a mobile phone, a wearable device, or a monitoring device.

13. The device of claim 11, wherein the holder is made of titanium alloy.

14. The device of claim 13, wherein the titanium alloy comprises titanium, aluminum, and vanadium (V), a content of aluminum in the titanium alloy is 6 wt. %, and a content of vanadium in the titanium alloy is 4 wt. %.

15. The device of claim 14, wherein the titanium alloy further comprises iron and oxygen, a content of iron in the titanium alloy is less than or equal to 0.25 wt. %, and a content of oxygen in the titanium alloy is less than or equal to 0.2 wt. %.

16. The device of claim 11, wherein the lens module further comprises an adhesive layer arranged in the groove, and the adhesive layer fixes the sensor in the groove.

17. The device of claim 11, wherein the circuit board comprises a first rigid board portion, a second rigid board portion, a flexible board portion arranged between the first rigid board portion and the second rigid board portion, and an electronic component; the circuit board has a first surface facing the holder and a second surface opposite to the first surface, the electronic component is arranged on the first surface of the first rigid board portion, and the holder is arranged on the first surface of the first rigid board portion.

18. The device of claim 17, wherein the circuit board further comprises an electrical connection portion arranged on the second surface of the second rigid board portion, and the electrical connection portion comprises a connector or gold fingers.

19. The device of claim 11, wherein the lens module further comprises a filter arranged in the cavity and located on an optical path of the lens.

20. The device of claim 11, wherein the lens comprises a first lens portion, a second lens portion, a third lens portion, a fourth lens portion, a fifth lens portion, and a sixth lens portion, which are connected in sequence and coaxially arranged.
